(19) United States
(12) Patent Application Publication
(10) Pub. No.: US 2025/0351818 A1
(43) Pub. Date: Nov. 20, 2025

(54) PESTICIDAL BAIT COMPOSITION AND PROCESSES RELATED THERETO

(71) Applicant: CORTEVA AGRISCIENCE, LLC, INDIANAPOLIS, IN (US)

(72) Inventors: ADEGOKE AKINSOLA, JOHNSTON, IA (US); RAY BOUCHER, LEBANON, IN (US); JAQUELINE BUENO DE CAMPOS, URBAN (BR); MARIO HENRIQUE DAL POGETTO, MOGO-MIRIM (BR); MOIRA ESSON, INDIANAPOLIS, IN (US); LUIS ENRIQUE GOMEZ, CARMEL, IN (US); IMRE MEZEI, LEÁNYFALU (HU); KE MIN, ZIONSVILLE, IN (US); TIMOTHY M. NOWATZKI, GRANGER, IA (US); MELISSA MARIE WILLRICH SIEBERT, GREENVILLE, MS (US); RAJEEV RANJAN SINHA, WHITESTOWN, IN (US); PABLO VALVERDE, ZIONSVILLE, IN (US)

(73) Assignee: CORTEVA AGRISCIENCE, LLC, INDIANAPOLIS, IN (US)

(21) Appl. No.: 18/869,272

(22) PCT Filed: May 4, 2023
(86) PCT No.: PCT/US23/20928

§ 371 Date: Nov. 25, 2024

Related U.S. Application Data
(60) Provisional application No. 63/346,350, filed on May 27, 2022.
(60) Provisional application No. 63/495,829, filed on Apr. 13, 2023.

(51) Int. Cl. A01N 25/00; A01N 43/16; A01N 43/90; A01N 47/10; A01N 47/40; A01N 65/44; A01P 17/00

(52) U.S. Cl. CPC A01N 25/006; A01N 43/16; A01N 43/90; A01N 47/10; A01N 47/40; A01N 65/44; A01P 17/00

(57) ABSTRACT

A pesticidal bait formulation for the control of pests harmful to agriculture.

### CROSS REFERENCE TO RELATED APPLICATIONS

This application claims the benefit of U.S. Provisional Application No. 63/495,829, filed Apr. 13, 2023 and claims the benefit of U.S. Provisional Application No. 63/346,350, filed May 27, 2022.

### BACKGROUND OF THIS DISCLOSURE

Fall armyworm (Spodoptera frugiperda) is a well-known sporadic and long-distance migratory pest. Native to tropical and sub-tropical America, it has recently invaded Africa, followed by Southern Europe, west and south Asia. The fall armyworm larvae feed on young leaf whorls, ears and tassels, causing substantial damage to many crops especially maize. In the infestation geography, maize is produced by millions of smallholder farmers, with a predominantly mixed crop-livestock farming style. Although fall armyworm represents a real threat to the livelihood of these farmers, use of insecticides as a pest management tool for them, especially in Africa, is minimal, largely due to shortage of information, inaccessibility of appropriate and effective products, shortage of water, and high costs. There is a significant need to develop an insecticide formulation for these small-holder farmers, with the requirements including but not limited to: (1) highly efficient with observable effects; (2) easy to apply; (3) minimal water involved during application; and (4) lower impact on the environment.

### DETAILED DESCRIPTION OF THIS DISCLOSURE

We have now developed a ready-to-use bait formulation in response to the four requirements. The bait formulation described in this disclosure can be easily stored and transported, and easily applied to the corn whorls by hand or by hand-held applicators. A wide variety of hand held applicators are commercially available for bait applications. By using this formulation, the use rate of spinetoram can be lowered to 1-5 grams per hectare (g/ha), which is significantly lower than the foliar spray spinetoram rate of 24-32 g/ha to control fall armyworm in a corn field. Farmers do not need water to apply the formulation, and the application process is straightforward. Application of the bait formulation causes minimal drift and leaves a minimal active ingredient footprint in the environment.

The pesticidal bait compositions in this disclosure can comprise more than one pesticide. For example, the following are listed in the Insecticide Resistance Action Committee (IRAC) most recent mode if action classification list online at https://irac-online.org/mode-of-action/classification-online: https://irac-online.org/mode-of-action/classification-online/: abamectin, acequinocyl, acetamiprid, acrinathrin, acynonapyr, afidopyropen, allethrin, alpha-cypermethrin, amitraz, azadirachtin, B.t. var. aizawai, B.t. var. israelensis, B.t. var. kurstaki, B.t. var. tenebrionensis, Bacillus sphaericus, bensultap, benzoximate, benzpyrimoxan, beta-cyfluthrin, beta-cypermethrin, bifenazate, bifenthrin, bioallethrin, bioallethrin S-cyclopentenyl, bioresmethrin, bistrifluron, broflanilide, bromopropylate, buprofezin, chinomethionat, chlorantraniliprole, chlorfenapyr, chlorfluazuron, chromafenozide, clofentezine, clothianidin, cyantraniliprole, cyclaniliprole, cycloprothrin, cyenopyrafen, cyflumetofen, cyfluthrin, cyhalothrin, cypermethrin, cyphenothrin [(1R)-trans-isomers], cyromazine, dazomet, d-cis-trans allethrin, deltamethrin, diafenthiuron, dicloromezotiaz, dicofol, diflovidazin, diflubenzuron, dimpropyridaz, dinotefuran, d-trans allethrin, emamectin benzoate, empenthrin [(EZ)-(1R)-isomers], esfenvalerate, etofenprox, etoxazole, fenazaquin, fenoxycarb, fenpropathrin, fenpyroximate, fenvalerate, flometoquin, flonicamid, fluacrypyrim, flubendiamide, flucycloxuron, flucythrinate, flufenoxuron, flumethrin, flupyradifurone, flupyrimin, fluxametamide, gamma-cyhalothrin, halfenprox, halofenozide, hexaflumuron, hexythiazox, hydramethylnon, hydroprene, imidacloprid, indoxacarb, isocycloseram, kadethrin, kinoprene, lambda-cyhalothrin, lepimectin, lufenuron, metaflumizone, metam, methoprene, methoxychlor, methoxyfenozide, milbemectin, nitenpyram, novaluron, noviflumuron, permethrin, phenothrin [(1R)-trans-isomer], prallethrin, propargite, pyflubumide, pymetrozine, pyrethrins (pyrethrum), pyridaben, pyrifluquinazon, pyrimidifen, pyriproxyfen, resmethrin, silafluofen, spinetoram, spinosad, spirodiclofen, spiromesifen, spiropidion, spirotetramat, sulfluramid, sulfoxaflor, tau-fluvalinate, tebufenozide, tebufenpyrad, teflubenzuron, tefluthrin, tetradifon, tetramethrin, tetramethrin [(1R)-isomers], tetraniliprole, theta-cypermethrin, thiacloprid, thiamethoxam, thiocyclam, thiosultap-sodium, tolfenpyrad, tralomethrin, transfluthrin, triflumezopyrim, triflumuron, and zeta-cypermethrin.

However, currently it is most preferred to use the active ingredient with the common name spinetoram. This active ingredient is also known by the IUPAC name as a mixture of
50-90% (2R,3aR,5aR,5bS,9S,13S,14R,16aS,16bR)-2-[(6-deoxy-3-O-ethyl-2,4-di-O-methyl-α-L-mannopyranosyl)oxy]-13-{[(2R,5S,6R)-5-(dimethylamino)tetrahydro-6-methylpyran-2-yl]oxy}-9-ethyl-2,3,3a,4,5,5a,5b,6,9,10,11,12,13,14,16a, 16b-hexadecahydro-14-methyl-1H-as-indaceno [3,2-d]oxacyclododecine-7,15-dione and
50-10% (2S,3aR,5aS,5bS,9S,13S,14R,16aS,16bS)-2-[(6-deoxy-3-O-ethyl-2,4-di-O-methyl-α-L-mannopyranosyl)oxy]-13-{[(2R,5S,6R)-5-(dimethylamino)tetrahydro-6-methylpyran-2-yl]oxy}-9-ethyl-2,3,3a,5a,5b,6,9,10,11,12,13,14,16a,16b-tetradecahydro-4,14-dimethyl-1H-as-indaceno [3,2-d]oxacyclododecine-7,15-dione.

The CAS Registry Numbers of the components of this mixture are 187166-40-1 (major component) and 187166-15-0 (minor component).

The structures are shown below

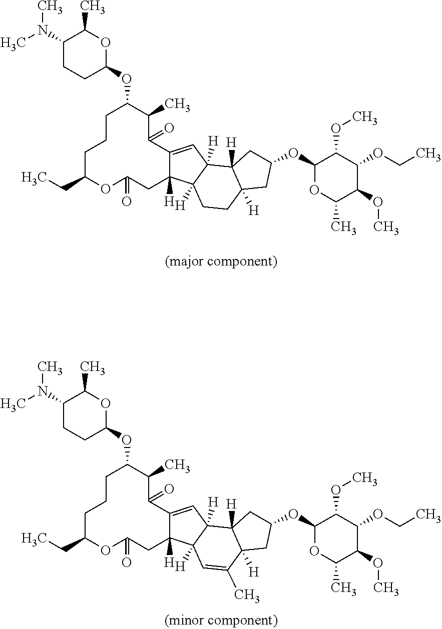

Spinetoram is available commercially as Jemvelva™ active, which is known for its exceptional environmental and toxicological profile. Spinetoram also has preferable properties such as a broad insecticidal spectrum and excellent insecticide activity against insect pests which are resistant to various existing insecticides.

Additionally, it is also preferred to use more than one pesticide for a variety of reasons. Such as, for example, using two or more pesticides to more efficiently to control one or more pests. Currently, two, and in in some cases three, pesticides may be used to control more than one pest at the same time as well as reducing the chance of resistance emerging in a pest.

The amount of pesticide to use in the pesticidal bait compositions, based on the total weight of a pesticidal bait composition, is from about 0.8 weight percent to about 0.01 weight percent, preferably from about 0.4 weight percent to about 0.03 weight percent, and even more preferably from about 0.2 weight percent to about 0.05 weight percent. Of course, the pesticidal weight percent will vary depending on various factors such as, local environmental conditions and pest control effects desired, among other factors.

Corn grits are known around the world. It is, in general, made from dried and ground corn. Corn grits are available from many companies, for example “Corn Grits G108” or “Corn Grits G101” are both available from Godawari Industries (https://www.godawari.com/). As another example, Homestead Gristmill Stoneground Grits, available in a variety of colors (https://www.homesteadgristmillstore.com). Additionally, the machinery used to make corn grits as readily available from many sources such as SHULIY Group Co. Ltd. (https://www.shuliy.com/product/corn-grit-making-machine/). Generally, a course grind of the corn grits is desired for formulation of the pesticide bait composition but nearly any desired size can be obtained and used. However, in general, a particle size of corn grits about from about 5000 microns to about 500 microns, preferably from about 2500 microns to about 1000 microns may be used to get the desired particle size.

Corn grits may also be made with corn containing transgenic Bacillus thuringiensis. This will provide additional means to control Fall Army Worm and additional insects that consume the pesticide bait.

Another option is using grounded corn cob by itself to replace corn grits. Additionally, mixtures of corn grits, corn grits containing transgenic Bacillus thuringiensis, and grounded corn cob may also be used.

The amount of corn grits to use in the pesticide bait compositions, based on the total weight of a pesticide bait composition is from about 99 weight percent to about 93 weight percent, preferably from about 99 weight percent to about 95 weight percent, and even more preferably from about 98 weight percent to about 96 weight percent. Of course, the corn grits weight percent will vary depending on various factors such as, local environmental conditions and pest control effects desired, among other factors.

There are many known binders in the formulation arts. A binder to bind the components of the pesticide bait compositions so that the desired size and shape of the pesticide bait composition is obtained may be selected, for example, from a natural oil such as, avocado oil, canola oil, coconut oil, corn oil, flaxseed oil, grapeseed oil, olive oil, peanut oil, safflower oil, sunflower oil, vegetable oil, and walnut oil.

The amount of binder to use in the pesticide bait compositions, based on the total weight of a pesticide bait composition, is from about 6 weight percent to about 1 weight percent, preferably about 5 weight percent to about 1 weight percent, and even more preferably about 4 weight percent to about 2 weight percent. Of course, the binder weight percent will vary depending on various factors such as, local environmental conditions, other components in the composition, and the desired shape and size of the pesticide bait composition, among other factors.

Other components to use in the pesticide bait composition are for example, biocides, embittering agents, colorants, solvents, stabilizers, among other known and useful bait components.

A microbial biocide may be used in the pesticide bait compositions. Examples of biocides include natural pyrethrum (from Chrysanthemum flowers), bitumen, camphor, vinegar, rose water, sodium benzoate, potassium benzoate, benzoic acid, propionic acid, sorbic acid, sodium nitrite, potassium sulfite, 2-Methyl-4-isothiazolin-3-one (MIT), 5-chloro-2-methyl-4-isothiazolin-3-one (CIT), 1,2-Benzisothiazolin-3-one (BIT), Chloromethyl-methylisothiazolone (CMIT/MIT), sodium sorbate, potassium sorbate, and calcium sorbate.

The amount of biocide to use in the pesticide bait compositions, based on the total weight of a pesticide bait composition, is from about 0.6 weight percent to about 0.005 weight percent, preferably from about 0.3 weight percent to about 0.001 weight percent, and even more preferably from about 0.15 weight percent to about 0.02 weight percent. Of course, the biocide weight percent will vary depending on various factors such as, local environmental conditions, biological organisms in the environment, to prevent or reduce microbial growth, and other components in the composition, among other factors.

An embittering agent, also known as a bitterant, may be in the pesticide bait compositions. Examples of embittering agents are denatonium, sucrose octaacetate, quercetin, brucine, and quassin.

The amount of embittering agent to use in the pesticide bait compositions, based on the total weight of a pesticide bait composition, is from about 0.6 weight percent to about 0.005 weight percent, preferably from about 0.3 weight percent to about 0.001 weight percent, and even more preferably from about 0.15 weight percent to about 0.02 weight percent. Of course, the embittering agent weight percent will vary depending on various factors such as, local environmental conditions, effects on the pests, and to discourage accidental exposure, among other factors.

A stabilizer may be in the pesticide bait compositions. Examples of stabilizers include butylated hydroxyanisole (BHA), butylated hydroxytoluene (BHT), propyl gallate (PG), tert-butyl hydroquinone (TBHQ), 2-naphthol (2NL), 4-phenylphenol (OPP) and 2,4-dichlorophenoxyacetic acid (2,4-DA).

The amount of stabilizer to use in the pesticide bait compositions, based on the total weight of a pesticide bait composition, is from about 0.6 weight percent to about 0.005 weight percent, preferably from about 0.3 weight percent to about 0.001 weight percent, and even more preferably from about 0.15 weight percent to about 0.01 weight percent. Of course, the stabilizer weight percent will vary depending on various factors such as, local environmental conditions and other components in the composition, among other factors.

A colorant may be in the pesticide bait compositions. There are many colorants available such as, Brilliant Blue, E133 (Blue shade), Indigotine, E132 (Dark Blue shade), Fast Green, E143 (Bluish green shade), Allura Red AC, E129 (Red shade), Erythrosine, E127 (Pink shade), Tartrazine, E102 (Yellow shade), Sunset Yellow, E110 (Orange shade). However, red colorants such as Lithol rubin BK, (E180), Amaranth (E123), Sudan III, and red 2G (E128) may also be used. Currently it is preferred to use red colorants.

The amount of colorant to use in the pesticide bait compositions, based on the total weight of a pesticide bait composition, is from about 0.6 weight percent to about 0.005 weight percent, preferably from about 0.3 weight percent to about 0.001 weight percent, and even more preferably from about 0.15 weight percent to about 0.01 weight percent. Of course, the colorant weight percent will vary depending on various factors such as, local environmental conditions, and other components in the composition, among other factors.

A solvent may be in the pesticide bait compositions. Examples of solvents include dihydrolevoglucosenone and dimethyl sulfoxide. A solvent may be used to facilitate the mixing of components to formulate a more homogeneous pesticide bait.

The amount of solvent to use in the pesticide bait compositions, based on the total weight of a pesticide bait composition, is from about 0.6 weight percent to about 0.005 weight percent, preferably from about 0.3 weight percent to about 0.001 weight percent, and even more preferably from about 0.15 weight percent to about 0.01 weight percent. Of course, the stabilizer weight percent will vary depending on various factors such as, local environmental conditions and other components in the composition, among other factors.

The components of the desired pesticide bait composition may be mixed in any order. For example, a solvent composition can be produced using a solvent and mixing it with an embittering agent to make a homogeneous composition. Additionally, an oil composition can be produced using a binder mixed with a biocide, stabilizer, and spinetoram, to form a more homogeneous composition. A pesticide bait composition can be produced by mixing the oil composition and the solvent composition with corn grits until the liquid is evenly coated and distributed on corn grits the desired size and shape of the bait composition is obtained so that the bait composition can be placed into a corn whorl.

Another major problem is corn stunt disease. S. kunkelii, a spiroplasma often referred to as corn stunt spiroplasma and a Maize bushy stunt phytoplasma (MBSP) can both survive in the maize leafhopper (Dalbulus maidis), and it causes corn stunt disease. Foliar use of insecticides can be used to partially control Dalbulus maidis, however, the use of this method to control corn stunt disease is not very successful. kasugamycin (Ksg) is an aminoglycoside antibiotic. However, we have discovered that mixing kasugamycin with pesticides can control the Dalbulus maidis and S. kunkelii at the same time thereby helping to avoid corn stunt disease brought by the vector Dalbulus maidis. The amount of kasugamycin can vary from 20 g ai/ha to 100 g ai/ha in mixture with the insecticides when used in foliar applications, for example, spinetoram and sulfoxaflor at 18 g ai/ha+32 g ai/ha respectively, or spinetoram and methomyl at 18 g ai/ha and 220 g ai/ha, respectively. However, with the bait composition the amount of kasugamycin to use in the pesticidal bait compositions, based on the total weight of a pesticidal bait composition, is from about 2.0 weight percent to about 0.01 weight percent, preferably from about 1.0 weight percent to about 0.1 weight percent, and even more preferably from about 0.5 weight percent to about 0.25 weight percent. Of course, the kasugamycin weight percent will vary depending on various factors such as, local environmental conditions and pest control effects desired, among other factors.

### EXAMPLES

### Example One: Fall Armyworm Control with Spinetoram Sprayable Formulation and Ready to Use Bait

Untreated non-Bt corn seeds (Zea mays) were planted into a 4-inch plastic square pot containing about 200 ml of Kalamazoo, Michigan loamy sand soil (11% silt, 9% clay, 80% sand) with 1.6% organic matter. One seed was planted in the center of each pot. Nine pots containing one corn plant each at BBCH-14 (four unfolded leaves) were setup and used for each treatment. Two formulations containing spinetoram were used in this study. Foliar application of a suspension concentrate (SC) spinetoram insecticide (120 g ai/L) was done using a track sprayer set to deliver 200 L of pesticide-water mixture per ha (hectare). Four rates of the SC formulation: 1, 3, 9, and 27 g ai/ha were used. Plants were left inside the lab to dry at room temperature after foliar applications. A ready to use bait (RB) containing 1 g ai/Kg of formulated material. The RB formulation was prepared by producing a solvent composition using a solvent and mixing it with an embittering agent to make it homogeneous. Additionally, an oil composition was produced using a binder mixed with a biocide, stabilizer, and spinetoram, to form a homogeneous composition. As a final step, the oil composition and the solvent composition were mixed with corn grits until the desired size and shape of the bait was obtained so that the RB formulation was able to be placed into a corn whorl. Four rates of the RB formulation, 0.21, 0.7. 2.1, and 6.3 g ai/ha were used. One untreated set of plants was also included in this experiment. The list of treatments for this assay are presented in Table 1. Each treated plant was infested with 3 L3 fall armyworm larvae (FAW; Spodoptera frugiperda). Individual plants were bagged with 13×24 inch microperforated plastic bags (ClearBags®). Infested plants were held in a Greenhouse (25±2° C., 16-hour light: 8-hour dark, 40-50% RH) for four days until assessment of performance was done. Performance evaluation was done by assessing the larval survival age. Lethal concentrations were also calculated for both materials. Tukey's analysis (JMP) was used to conduct mean separation of the larval survival. The lethal concentration data for the two formulations was used to assess the percentage of relative activity between the RB and SC formulations of spinetoram. It was discovered that foliar spray treatments required 1486% more spinetoram to reach the LC₅₀ performance level of the RB formulation.

TABLE 1

| Treatment | | | | |
|---|---|---|---|---|
| Number | Formulation/active | Rate g ai/ha | | Application Rate |
| 1 | Spinetoram SC (120 g ai/L). | 1 | g ai/ha | 0.0417 ml formulated |
| | Foliar sprayed | | | product/L |
| | | | | (200 L/ha) |
| 2 | Spinetoram SC (120 g ai/L). | 3 | g ai/ha | 0.1251 ml formulated |
| | Foliar sprayed | | | product/L |
| | | | | (200 L/ha) |
| 3 | Spinetoram SC (120 g ai/L). | 9 | g ai/ha | 0.3753 ml formulated |
| | Foliar sprayed | | | product/L |
| | | | | (200 L/ha) |
| 4 | Spinetoram SC (120 g ai/L). | 7 | g ai/ha | 1.1259 ml formulated |
| | Foliar sprayed | | | product/L |
| | | | | (200 L/ha) |
| 5 | Spinetoram RB (1 g ai/kg RB). | 0.21 | g ai/ha* | 3 mg formulated |
| | Applied directly to the whorl | | | product/plant |
| 6 | Spinetoram RB (1 g ai/kg RB). | 0.7 | g ai/ha* | 10 mg formulated |
| | Applied directly to the whorl | | | product/plant |
| 7 | Spinetoram RB (1 g ai/kg RB). | 2.1 | g ai/ha* | 30 mg formulated |
| | Applied directly to the whorl | | | product/plant |
| 8 | Spinetoram RB (1 g ai/kg RB). | 6.3 | g ai/ha* | 90 mg formulated |
| | Applied directly to the whorl | | | product/plant |
| 9 | UTC | | | |

*adjusted to g ai/ha on a basis of 70,000 plants/ha

In the two following examples, kasugamycin by itself can reduce the progression of the disease and its mixture with pesticides can reduce the incidence of the disease and increase the crop yield.

### Example 2

A corn field with plants naturally infected by both phytoplasma and spiroplasma was sprayed with kasugamycin at 100 g ai/ha. The plants with 4 true-leaves were sprayed with 1 application/week for 4 weeks. Fifteen days after the first application and 15 days after the fourth spraying the severity of the stunts were evaluated visually, considering the percent of leaf area infected (showing symptoms). The severity of the disease was 27% at both treated and untreated plots after the first application and 15 days after the forth application the severity was 43% at the treated plots versus 54% at the untreated, reducing the progression of the disease in 20%.

### Example 3

Four foliar applications of pesticides solo and in mixture with kasugamycin were performed in corn plants in field starting at V2 (2 true-leaves) stage of the crop with 7 days apart. Four combinations of pesticides were tested: Spinetoram+sulfoxaflor at 18+32 g ai/ha solo and in mixture with kasugamycin at 20 g ai/ga and spinetoram+methomyl at 18+220 g ai/ha solo and mixture with kasugamycin at 20 g ai/ha. The incidence of plants with symptoms of stunts at 53 and 91 days after sowing and the yield were assessed. At 91 days after sowing spinetoram+methomyl solo had 12.5% plants with symptoms and its mixture with kasugamycin no symptoms were observed, while in the untreated the incidence was 22.5%. Spinetoram+sulfoxaflor solo showed 32.5% of plants with symptoms and its mixture with kasugamycin showed 12.5%. In comparison with the untreated spinetoram+methomyl solo and spinetoram+sulfoxaflor+kasugamycin reduced the progression of the disease in 44% and the mixture of spinetoram+methomyl+kasugamycin reduced in 100%. kasugamycin solo reduced the progression of the disease in 11%. Both mixtures spinetoram+sulfoxaflor and spinetoram+methomyl in mixture with kasugamycin increased the corn yield in 8.9% and 10.2% respectively.

In light of the preceding disclosure the following addition details (d) are provided.

1d. A pesticidal bait composition comprising:
(a) at least one pesticide wherein said at least one pesticide is abamectin, acequinocyl, acetamiprid, acrinathrin, acynonapyr, afidopyropen, allethrin, alpha-cypermethrin, amitraz, azadirachtin, B.t. var. aizawai, B.t. var. israelensis, B.t. var. kurstaki, B.t. var. tenebrionensis, Bacillus sphaericus, bensultap, benzoximate, benzpyrimoxan, beta-cyfluthrin, beta-cypermethrin, bifenazate, bifenthrin, bioallethrin, bioallethrin S-cyclopentenyl, bioresmethrin, bistrifluron, broflanilide, bromopropylate, buprofezin, chinomethionat, chlorantraniliprole, chlorfenapyr, chlorfluazuron, chromafenozide, clofentezine, clothianidin, cyantraniliprole, cyclaniliprole, cycloprothrin, cyenopyrafen, cyflumetofen, cyfluthrin, cyhalothrin, cypermethrin, cyphenothrin [(1R)-trans-isomers], cyromazine, dazomet, d-cis-trans allethrin, deltamethrin, diafenthiuron, dicloromezotiaz, dicofol, diflovidazin, diflubenzuron, dimpropyridaz, dinotefuran, d-trans allethrin, emamectin benzoate, empenthrin [(EZ)-(1R)-isomers], esfenvalerate, etofenprox, etoxazole, fenazaquin, fenoxycarb, fenpropathrin, fenpyroximate, fenvalerate, flometoquin, flonicamid, fluacrypyrim, flubendiamide, flucycloxuron, flucythrinate, flufenoxuron, flumethrin, flupyradifurone, flupyrimin, fluxametamide, gamma-cyhalothrin, halfenprox, halofenozide, hexaflumuron, hexythiazox, hydramethylnon, hydroprene, imidacloprid, indoxacarb, isocycloseram, kadethrin, kinoprene, lambda-cyhalothrin, lepimectin, lufenuron, metaflumizone, metam, methoprene, methoxychlor, methoxyfenozide, milbemectin, nitenpyram, novaluron, noviflumuron, permethrin, phenothrin [(1R)-trans-isomer], prallethrin, propargite, pyflubumide, pymetrozine, pyrethrins (pyrethrum), pyridaben, pyrifluquinazon, pyrimidifen, pyriproxyfen, resmethrin, silafluofen, spinetoram, spinosad, spirodiclofen, spiromesifen, spiropidion, spirotetramat, sulfluramid, sulfoxaflor, tau-fluvalinate, tebufenozide, tebufenpyrad, teflubenzuron, tefluthrin, tetradifon, tetramethrin, tetramethrin [(1R)-isomers], tetraniliprole, theta-cypermethrin, thiacloprid, thiamethoxam, thiocyclam, thiosultap-sodium, tolfenpyrad, tralomethrin, transfluthrin, triflumezopyrim, triflumuron, or zeta-cypermethrin;
(b) corn grit, corn grits containing transgenic Bacillus thuringiensis, grounded corn cob, or a mixture thereof; and
(c) a binder.
   1.25d A pesticidal bait composition according to detail 1d wherein at least one pesticide is two pesticides used in the pesticide bait.
   1.50d A pesticidal bait composition according to detail 1d wherein at least one pesticide is three pesticides used in the pesticide bait.
   2d. A pesticidal bait composition according to detail 1d wherein said pesticide is spinetoram.
   2.25d A pesticidal bait composition according to detail 1d wherein at least one pesticide is two pesticides used in the pesticide bait.
   2.50d A pesticidal bait composition according to detail 1d wherein at least one pesticide is three pesticides used in the pesticide bait.
   3d. A pesticide bait composition according to detail 2d wherein said bait composition comprises a pesticide that is a mixture of spinetoram and one or more additional active ingredients wherein said additional active ingredients are Bacillus thuringiensis, bifenthrin, cyfluthrin, cypermethrin, deltamethrin, gamma-cyhalothrin, lambda-cyhalothrin, permethrin, spinosad, trichlorfon, or mixtures thereof.
   4d. A pesticide bait composition according to any of the previous details wherein the amount of pesticide in the pesticidal bait composition, based on the total weight of the pesticidal bait composition, is from about 0.8 weight percent to about 0.01 weight percent.
   5d. A pesticide bait composition according to any of the previous details wherein the amount of pesticide in the pesticidal bait composition, based on the total weight of the pesticidal bait composition, is from about 0.4 weight percent to about 0.03 weight percent.
   6d. A pesticide bait composition according to any of the previous details wherein the amount of pesticide in the pesticidal bait composition, based on the total weight of the pesticidal bait composition, is from about 0.2 weight percent to about 0.05 weight percent.
   7d. A pesticidal bait composition according to any previous details wherein the amount of corn grits in the pesticide bait composition, based on the total weight of a pesticide bait composition, is from about 99 weight percent to about 93 weight percent.
   8d. A pesticidal bait composition according to any previous details wherein the amount of corn grits in the pesticide bait composition, based on the total weight of a pesticide bait composition, is from about 99 weight percent to about 95 weight percent.
   9d. A pesticidal bait composition according to any previous details wherein the amount of corn grits in the pesticide bait composition, based on the total weight of a pesticide bait composition, is from about 98 weight percent to about 96 weight percent.
   10d. A pesticidal bait composition according to any previous details wherein the particle size of corn grits is from about 5000 microns to about 500 microns.
   11d. A pesticidal bait composition according to any previous details wherein the particle size of corn grits is from about 2500 microns to about 1000 microns.
   12d. A pesticidal bait composition according to any previous details wherein the corn grits are made with corn containing transgenic Bacillus thuringiensis.
   13d. A pesticidal bait composition according to any previous details wherein the binder is avocado oil, canola oil, coconut oil, corn oil, flaxseed oil, grapeseed oil, olive oil, peanut oil, safflower oil, sunflower oil, vegetable oil, walnut oil, or a mixture thereof.
   14d. A pesticidal bait composition according to any previous details wherein the amount of binder in the pesticide bait composition, based on the total weight of a pesticide bait composition, is from about 6 weight percent to about 1 weight percent.
   15d. A pesticidal bait composition according to any previous details wherein the amount of binder in the pesticide bait composition, based on the total weight of a pesticide bait composition, is from about 5 weight percent to about 1 weight percent.
   16d. A pesticidal bait composition according to any previous details wherein the amount of binder in the pesticide bait composition, based on the total weight of a pesticide bait composition, is from about 4 weight percent to about 2 weight percent.
   17d. A pesticidal bait composition according to any previous details wherein the pesticide bait composition also comprises a microbial biocide.
   18d. A pesticidal bait composition according to detail 17d wherein the microbial biocide is natural pyrethrum, bitumen, camphor, vinegar, rose water, sodium benzoate, potassium benzoate, benzoic acid, propionic acid, sorbic acid, sodium nitrite, potassium sulfite, 2-Methyl-4-isothiazolin-3-one, 5-chloro-2-methyl-4-isothiazolin-3-one, 1,2-Benzisothiazolin-3-one, chloromethyl-methylisothiazolone, sodium sorbate, potassium sorbate, calcium sorbate, or mixtures thereof.
   19d. A pesticidal bait composition according to detail 17d or 18d wherein the amount of biocide in the pesticide bait composition, based on the total weight of a pesticide bait composition, is from about 0.6 weight percent to about 0.005 weight percent.
   20d. A pesticidal bait composition according to detail 17d or 18d wherein the amount of biocide in the pesticide bait composition, based on the total weight of a pesticide bait composition, is from about 0.3 weight percent to about 0.001 weight percent.
   21d. A pesticidal bait composition according to detail 17d or 18d wherein the amount of biocide in the pesticide bait composition, based on the total weight of a pesticide bait composition, is from about 0.15 weight percent to about 0.02 weight percent.
   22d. A pesticidal bait composition according to any previous details wherein the pesticide bait composition also comprises an embittering agent.
   23d. A pesticidal bait composition according to detail 22d wherein the embittering agent is denatonium, sucrose octaacetate, quercetin, brucine, quassin, or mixtures thereof.
   24d. A pesticidal bait composition according to detail 22d or 23d wherein the amount of embittering agent to in the pesticide bait composition, based on the total weight of a pesticide bait composition, is from about 0.6 weight percent to about 0.005 weight percent.
   25d. A pesticidal bait composition according to detail 22d or 23d wherein the amount of embittering agent in the pesticide bait composition, based on the total weight of a pesticide bait composition, is from about 0.3 weight percent to about 0.001 weight percent.
   26d. A pesticidal bait composition according to detail 22d or 23d wherein the amount of embittering agent in the pesticide bait composition, based on the total weight of a pesticide bait composition, is from about 0.15 weight percent to about 0.02 weight percent.
   27d. A pesticide bait composition according to any of the previous details wherein said pesticide bait composition further comprises a stabilizer.
   28d. A pesticide bait composition according to detail 27d wherein the stabilizer is butylated hydroxyanisole, butylated hydroxytoluene, propyl gallate, tert-butyl hydroquinone, 2-naphthol, 4-phenylphenol, 2,4-dichlorophenoxyacetic acid, or mixtures thereof.
   29d. A pesticide bait composition according to detail 27d or 28d wherein the amount of stabilizer in the pesticide bait composition, based on the total weight of the pesticide bait composition, is from about 0.6 weight percent to about 0.005 weight percent.
   30d. A pesticide bait composition according to detail 27d or 28d wherein the amount of stabilizer in the pesticide bait composition, based on the total weight of the pesticide bait composition, is from about 0.3 weight percent to about 0.001 weight percent.
   31d. A pesticide bait composition according to detail 27d or 28d wherein the amount of stabilizer in the pesticide bait composition, based on the total weight of the pesticide bait composition, is from about 0.15 weight percent to about 0.01 weight percent.
   32d. A pesticide bait composition according to any of the previous details wherein said pesticide bait composition further comprises a colorant.
   33d. A pesticide bait composition according to detail 32d wherein the colorant is Brilliant Blue, E133 (Blue shade), Indigotine, E132 (Dark Blue shade), Fast Green, E143 (Bluish green shade), Allura Red AC, E129 (Red shade), Erythrosine, E127 (Pink shade), Tartrazine, E102 (Yellow shade), Sunset Yellow, E110 (Orange shade), Lithol rubin BK, (E180), Amaranth (E123), Sudan III, and red 2G (E128), or mixtures thereof.
   34d. A pesticide bait composition according to details 32d or 33d wherein the amount of colorant in the pesticide bait composition, based on the total weight of the pesticide bait composition, is from about 0.6 weight percent to about 0.005 weight percent.
   35d. A pesticide bait composition according to details 32d or 33d wherein the amount of colorant in the pesticide bait composition, based on the total weight of the pesticide bait composition, is from about 0.3 weight percent to about 0.001 weight percent.
   36d. A pesticide bait composition according to details 32d or 33d wherein the amount of colorant in the pesticide bait composition, based on the total weight of the pesticide bait composition, is from about 0.15 weight percent to about 0.01 weight percent.
   37d. A pesticide bait composition according to any of the previous details wherein said pesticide bait composition further comprises a solvent.
   38d. A pesticide bait composition according to detail 37d wherein the solvent is dihydrolevoglucosenone, dimethyl sulfoxide, or a mixture thereof.
   39d. A pesticide bait composition according to details 37d or 38d wherein the amount of solvent in the pesticide bait composition, based on the total weight of the pesticide bait composition, is from about 0.6 weight percent to about 0.005 weight percent.
   40d. A pesticide bait composition according to details 37d or 38d wherein the amount of solvent in the pesticide bait composition, based on the total weight of the pesticide bait composition, is from about 0.3 weight percent to about 0.001 weight percent.
   41d. A pesticide bait composition according to details 37d or 38d wherein the amount of solvent in the pesticide bait composition, based on the total weight of the pesticide bait composition, is from about 0.15 weight percent to about 0.01 weight percent.
   42d. A pesticide bait composition according to any of the previous details wherein said pesticide bait composition further comprises kasugamycin.
   43d A process to control Fall Army Worm comprising using a pesticide bait composition according to any of the previous details.
   44d. A process to control Fall Army Worm, Dalbulus maidis, or both, comprising using a pesticide bait composition according to any of the previous details including detail 42d.
   45d. A process according to 43d wherein the pesticide bait composition is placed in a corn whorl.

The claims follow.

1. A pesticidal bait composition comprising:
(a) at least one pesticide wherein said at least one pesticide is abamectin, acequinocyl, acetamiprid, acrinathrin, acynonapyr, afidopyropen, allethrin, alpha-cypermethrin, amitraz, azadirachtin, B.t. var. aizawai, B.t. var. israelensis, B.t. var. kurstaki, B.t. var. tenebrionensis, Bacillus sphaericus, bensultap, benzoximate, benzpyrimoxan, beta-cyfluthrin, beta-cypermethrin, bifenazate, bifenthrin, bioallethrin, bioallethrin S-cyclopentenyl, bioresmethrin, bistrifluron, broflanilide, bromopropylate, buprofezin, chinomethionat, chlorantraniliprole, chlorfenapyr, chlorfluazuron, chromafenozide, clofentezine, clothianidin, cyantraniliprole, cyclaniliprole, cycloprothrin, cyenopyrafen, cyflumetofen, cyfluthrin, cyhalothrin, cypermethrin, cyphenothrin [(1R)-trans-isomers], cyromazine, dazomet, d-cis-trans allethrin, deltamethrin, diafenthiuron, dicloromezotiaz, dicofol, diflovidazin, diflubenzuron, dimpropyridaz, dinotefuran, d-trans allethrin, emamectin benzoate, empenthrin [(EZ)-(1R)-isomers], esfenvalerate, etofenprox, etoxazole, fenazaquin, fenoxycarb, fenpropathrin, fenpyroximate, fenvalerate, flometoquin, flonicamid, fluacrypyrim, flubendiamide, flucycloxuron, flucythrinate, flufenoxuron, flumethrin, flupyradifurone, flupyrimin, fluxametamide, gamma-cyhalothrin, halfenprox, halofenozide, hexaflumuron, hexythiazox, hydramethylnon, hydroprene, imidacloprid, indoxacarb, isocycloseram, kadethrin, kinoprene, lambda-cyhalothrin, lepimectin, lufenuron, metaflumizone, metam, methoprene, methoxychlor, methoxyfenozide, milbemectin, nitenpyram, novaluron, noviflumuron, permethrin, phenothrin [(1R)-trans-isomer], prallethrin, propargite, pyflubumide, pymetrozine, pyrethrins (pyrethrum), pyridaben, pyrifluquinazon, pyrimidifen, pyriproxyfen, resmethrin, silafluofen, spinetoram, spinosad, spirodiclofen, spiromesifen, spiropidion, spirotetramat, sulfluramid, sulfoxaflor, tau-fluvalinate, tebufenozide, tebufenpyrad, teflubenzuron, tefluthrin, tetradifon, tetramethrin, tetramethrin [(1R)-isomers], tetraniliprole, theta-cypermethrin, thiacloprid, thiamethoxam, thiocyclam, thiosultap-sodium, tolfenpyrad, tralomethrin, transfluthrin, triflumezopyrim, triflumuron, or zeta-cypermethrin;
(b) corn grit, corn grits containing transgenic Bacillus thuringiensis, grounded corn cob, or a mixture thereof; and
(c) a binder.

2. The pesticidal bait composition according to claim 1 wherein said at least one pesticide is two pesticides used in the pesticide bait.

3. The pesticidal bait composition according to claim 1 wherein said at least one pesticide is three pesticides used in the pesticide bait.

4. The pesticidal bait composition according to claim 1 wherein said at least one pesticide includes spinetoram.

5. The pesticidal bait composition according to claim 4 wherein said at least one pesticide is two pesticides used in the pesticide bait.

6. The pesticidal bait composition according to claim 4 wherein said at least one pesticide is three pesticides used in the pesticide bait.

7. The pesticide bait composition according to claim 4 wherein said bait composition comprises a pesticide that is a mixture of spinetoram and one or more additional active ingredients wherein said additional active ingredients are Bacillus thuringiensis, bifenthrin, cyfluthrin, cypermethrin, deltamethrin, gamma-cyhalothrin, lambda-cyhalothrin, permethrin, spinosad, trichlorfon, or mixtures thereof.

8. The pesticide bait composition according to claim 1 wherein the amount of pesticide in the pesticidal bait composition, based on the total weight of the pesticidal bait composition, is from about 0.8 weight percent to about 0.01 weight percent.

9. The pesticidal bait composition according to claim 1 wherein the amount of corn grits in the pesticide bait composition, based on the total weight of a pesticide bait composition, is from about 99 weight percent to about 93 weight percent.

10. The pesticidal bait composition according to claim 1 wherein the binder is avocado oil, canola oil, coconut oil, corn oil, flaxseed oil, grapeseed oil, olive oil, peanut oil, safflower oil, sunflower oil, vegetable oil, walnut oil, or a mixture thereof.

11. The pesticide bait composition according to claim 1 wherein said pesticide bait composition further comprises kasugamycin.

12. A process to control Fall Army Worm comprising using a pesticide bait composition according to claim 1.

13. A process to control Fall Army Worm, Dalbulus maidis, or both, comprising using a pesticide bait composition according to claim 1.

14. The process according to claim 12 wherein the pesticide bait composition is placed in a corn whorl.

15. The pesticide bait composition according to claim 4, wherein said pesticide bait composition further comprises kasugamycin.
